(19) United States
(12) Patent Application Publication
(10) Pub. No.: US 2007/0242587 A1
(43) Pub. Date: Oct. 18, 2007

(54) Information Recording Device and Method, Information Reproducing Device and Method, and Computer Program

(76) Inventors: Keiji Katata, Saitama (JP); Kazuo Kuroda, Saitama (JP); Takeshi Koda, Saitama (JP)

Correspondence Address: YOUNG & THOMPSON, 745 SOUTH 23RD STREET, 2ND FLOOR, ARLINGTON, VA, 22202, US

(21) Appl. No.: 11/596,646

(22) PCT Filed: May 16, 2005
(86) PCT No.: PCT/JP05/08887

§ 371 Date: Jan. 12, 2007

(30) Foreign Application Priority Data
May 17, 2004 (JP) 2004-146298

(51) Int. Cl. G11B 20/12

(52) U.S. Cl. 369/59.25

(57) ABSTRACT

An information recording apparatus includes a recording device capable of recording record information onto an information recording medium having a plurality of recording layers; a selecting device for sequentially selecting one recording layer to record therein the record information, such that a recording area of the record information recorded into each of the plurality of recording layers substantially uniformly expands, in accordance with the recording of the record information; a generating device for generating virtual reference information including logical address information on the information recording medium corresponding to the record information on a logical address space such that a recording position of the record information on the logical address space of the information recording medium is in a recording order of the record information onto the information recording medium; and a controlling device for controlling the recording device to record the generated virtual reference information onto the information recording medium.

### TECHNICAL FIELD

The present invention relates to an information recording apparatus, such as a DVD recorder, for example, an information recording method, and a computer program which makes a computer function as the information recording apparatus.

### BACKGROUND ART

In an information recording medium, such as an optical disc, like a CD-ROM (Compact Disc-Read Only Memory), a CD-R (Compact Disc-Recordable), a DVD-ROM, or the like, for example, there is also developed an optical disc or the like of a multilayer type or a dual-layer type, in which a plurality of recording layers are laminated or stacked on the same substrate. More specifically, the dual-layer optical disc has a first recording layer (referred to as a “L0 layer” in this application, as occasion demands), as the first layer, which is located on the front (i.e. a side closest to an optical pickup), viewed from the irradiation side of laser light in recording information by using the information recording apparatus, and further has a semi-transparent reflective coating or film, located on the rear thereof (i.e. a side farther from the optical pickup). As the second recording layer, it has a second recording layer (referred to as a “L1 layer” in this application, as occasion demands), located on the rear of the semitransparent reflective film through a middle layer, such as an adhesive layer, and further has a reflective film located on the rear thereof (refer to Patent documents 1 and 2). In preparing such a multilayer type information recording medium, the L0 layer and the L1 layer are individually formed and bonded in the end, to thereby prepare the two-layer type optical disc at a low cost.

Moreover, as a method of managing the data recorded on the optical disc (e.g. a method of specifying the recording position of the data), it is common to use a file system. For example, in a DVD, UDF (Universal Disk Format) is defined as a standard file system. Particularly, in write-once type media on which writing can be performed only once, there is a method of managing the file by using a VAT (Virtual Allocation Table). The management method using the VAT is used mainly when the file system information of the file recorded on the write-once type optical disc is rewritten.

Patent document 1: Japanese Patent Application Laid Open NO. 2000-503446

Patent document 2: Japanese Patent Application Laid Open NO. 2001-23237

Patent document 3: Japanese Patent Application Laid Open NO. 2002-150706

### DISCLOSURE OF INVENTION

### Subject to be Solved by the Invention

In such a dual-layer type optical disc, generally, the record information is firstly recorded into the L0 layer. After the data is recorded in the entire L0 layer, the data is recorded into the L1 layer. Therefore, there arises such a situation that the data is recorded in the entire L0 layer, whereas the data is recorded only in one portion of the L1 layer. If a finalize process is performed in such a situation to enable the reproduction of the information on the optical disc on an existing DVD-ROM player or the like, it is necessary to record dummy data in another portion of the L1 layer in which the data is not recorded. Thus, there is a technical problem that it takes more time to perform the finalize process, as compared to the data size of the actually recorded data.

In order to solve the above-mentioned conventional problems, it is therefore an object of the present invention to provide an information recording apparatus, an information recording method, an information reproducing apparatus, and an information reproducing method, which enable a finalize process to be quickly performed on an information recording medium having a plurality of recording layers, for example, and a computer program which makes a computer function as the information recording apparatus or the information reproducing method.

### MEANS FOR SOLVING THE SUBJECT

(Information Recording Apparatus)

The above object of the present invention can be achieved by an information recording apparatus provided with: a recording device capable of recording record information onto an information recording medium having a plurality of recording layers; a selecting device for sequentially selecting one recording layer to record therein the record information, such that a recording area of the record information recorded into each of the plurality of recording layers substantially uniformly expands, in accordance with the recording of the record information; a generating device for generating virtual reference information (e.g. a VAT described later) including logical address information (e.g. LBN and LBA, as a logical address, described later) on the information recording medium corresponding to the record information on a logical address space (e.g. a disc volume space described later) such that a recording position of the record information on the logical address space of the information recording medium is in a recording order of the record information onto the information recording medium; and a controlling device for controlling the recording device to record the generated virtual reference information onto the information recording medium.

According to the information recording apparatus of the present invention, by the operation of the recording device, it is possible to record the record information into the plurality of recording layers, as occasion demands. At this time, the one recording layer, which is a target of the recording operation performed by the recording device, is selected by the operation of the selecting device. The selecting device selects the one recording layer, as occasion demands, to substantially equalize (or uniformly expand) the recording area, in which the record information is already recorded, in each of the plurality of recording layers.

Particularly in the present invention, by the operation of the generating device, it is possible to generate the virtual reference information. The virtual reference information is constructed including the logical address information of the record information on the logical address space, such that the recording position of the record information on the logical address space of the information recording medium, recognized by the information recording apparatus of the present invention, is in the recording order of the record information. Namely, if three pieces of the record information (record information #1, record information #2, and record information #3) are recorded in this order, the virtual reference information including the logical address information of the record information is generated such that the recording positions thereof on the logical address space are also arranged (or disposed) in the order of the record information #1, the record information #2, and the record information #3. Then, by the operation of the controlling device, the virtual reference information is recorded into a predetermined recording area of the information recording medium.

By this, when the information recording apparatus of the present invention recognizes the recording position on the logical address space of the record information recorded on the information recording medium, it can properly recognize the recording position of the record information, with reference to the virtual reference information. In particular, it can recognize the recording position such that the recording position of the record information on the logical address space is in the recording order of the record information. Therefore, even if recording the record information, alternately or by turns, into each of the plurality of recording layers, the information recording apparatus can properly recognize the recording position of the recorded record information.

Then, the record information is recorded such that the recording area, in which the record information is already recorded, in each of the plurality of recording layers is substantially equal, so that it is possible to substantially equalize the extent (size) of the record information recorded into each of the plurality of recording layers. Thus, as compared to an information recording medium on which the record information is recorded into another recording layer after the record information is recorded into entire one recording layer, it is possible to reduce the size of the area or eliminate the area in which dummy data needs to be recorded in the finalize process.

Consequently, according to the information recording apparatus of the present invention, it is possible to reduce a time length required for the finalizing, which results in such a great advantage that the recording operation can be made efficient. Then, along with that, by referring the generated virtual reference information, as occasion demands, it is possible to properly record the record information into the plurality of recording layers, or properly reproduce the recorded record information.

In one aspect of the information recording apparatus of the present invention, the virtual reference information associates the recording order of the record information with the logical address information corresponding to the recording position.

According to this aspect, with reference to the virtual reference information in which the information indicating the recording order (e.g. a VAT entry number or the like, described later) is associated with the logical address information, it is possible to properly record the record information into the plurality of recording layers or properly reproduce the recorded record information.

In another aspect of the information recording apparatus of the present invention, if the record information is newly recorded, the generating device generates the virtual reference information by rewriting the logical address information corresponding to at least the record information whose recording position is changed on the logical address space, out of the record information recorded on the information recording medium.

According to this aspect, the virtual reference information is newly generated by rewriting the logical address information of the record information whose recording position on the logical address space is changed. By this, it is possible to properly generate the virtual reference information even if the record information is continuously recorded.

In another aspect of the information recording apparatus of the present invention, the generating device generates the virtual reference information every time the record information is newly recorded into the selected one recording layer.

According to this aspect, in whichever of the plurality of recording layers the record information is recorded, it is possible to properly generate the virtual reference information which reflects the recording of the record information. Therefore, even during the recording operation, it is possible to properly manage the recorded record information, with reference to the virtual reference information.

In another aspect of the information recording apparatus of the present invention, the generating device generates the virtual reference information if the information recording medium is finalized.

According to this aspect, it is unnecessary to generate the virtual reference information until the finalize process is performed, so that it is possible to improve the performance of the recording operation. Moreover, it is unnecessary to record the virtual reference information onto the information recording medium beyond necessity, so that it is possible to effectively use the recording capacity of the information recording medium.

Moreover, when the finalize process is performed, the virtual reference information is properly generated. Thus, it is possible to properly read and reproduce the record information, on an information reproducing apparatus for reproducing the record information recorded on this information recording medium.

In another aspect of the information recording apparatus of the present invention, it is further provided with a negating device for negating the generated virtual reference information.

According to this aspect, it is possible to negate the once generated virtual reference information if needed, by the operation of the negating device (e.g. it is possible to make the once generated virtual reference information impossible to be referred to by the information recording apparatus). For example, the virtual reference information may be generated, to thereby manage the record information recorded by using the virtual reference information. Alternatively, the virtual reference information may be negated, to thereby manage the record information recorded in another method.

(Information Recording Method)

The above object of the present invention can be also achieved by an information recording method in an information recording apparatus provided with: a recording device capable of recording record information onto an information recording medium having a plurality of recording layers, the information recording method provided with: a selecting process of sequentially selecting one recording layer to record therein the record information, such that a recording area of the record information recorded into each of the plurality of recording layers substantially uniformly expands, in accordance with the recording of the record information; a generating process of generating virtual reference information (e.g. a VAT described later) including logical address information (e.g. LBN or the like, as a logical address, described later) on the information recording medium corresponding to the record information on a logical address space (e.g. a disc volume space or the like described later) such that a recording position of the record information on the logical address space of the information recording medium is in a recording order of the record information onto the information recording medium; and a controlling process of controlling the recording device to record the generated virtual reference information onto the information recording medium.

According to the information recording method of the present invention, it is possible to receive the same various benefits as those of the information recording apparatus of the present invention.

Incidentally, in response to the various aspects of the information recording apparatus of the present invention described above, the information recording method of the present invention can adopt various aspects.

(Information Reproducing Apparatus)

The above object of the present invention can be also achieved by an information reproducing apparatus for reproducing the record information recorded on the information recording medium by the above-mentioned information recording apparatus of the present invention (including its various aspects), the information reproducing apparatus provided with: a first reproducing device for reproducing the virtual reference information; and a second reproducing device for reproducing the record information in the recording order of the record information onto the information recording medium, on the basis of the logical address information included in the virtual reference information reproduced by the first reproducing device.

According to the information reproducing apparatus of the present invention, it is possible to reproduce (or obtain) the virtual reference information by the operation of the first reproducing device. Then, on the basis of the logical address information included in the reproduced virtual reference information, the record information is reproduced by the operation of the second reproducing device. In particular, the virtual reference information includes the logical address information of the record information on the logical address space such that the recording position of the record information on the logical address space of the information recording medium is in the recording order of the record information onto the information recording medium. Thus, by the operation of the second reproducing device, it is possible to properly reproduce the record information in the recording order. Therefore, it is possible to properly reproduce the record information recorded on the information recording medium having the plurality of recording layers, with reference to the virtual reference information.

Incidentally, in response to the various aspects of the information recording apparatus of the present invention described above, the information reproducing apparatus of the present invention can adopt various aspects.

(Information Reproducing Method)

The above object of the present invention can be also achieved by an information reproducing method of reproducing the record information recorded on the information recording medium by the above-mentioned information recording apparatus of the present invention (including its various aspects), the information reproducing method provided with: a first reproducing process of reproducing the virtual reference information; and a second reproducing process of reproducing the record information in the recording order of the record information onto the information recording medium, on the basis of the logical address information included in the virtual reference information reproduced in the first reproducing process.

According to the information reproducing method of the present invention, it is possible to receive the same various benefits as those of the information reproducing apparatus of the present invention.

Incidentally, in response to the various aspects of the information reproducing apparatus of the present invention described above, the information reproducing method of the present invention can adopt various aspects.

(Computer Program)

The above object of the present invention can be also achieved by a first computer program for making the computer function as the above-mentioned information recording apparatus (including its various aspects). More specifically, the first computer program makes the computer function as at least one portion of the recording device, the selecting device, the generating device, and the controlling device.

According to the first computer programs of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the information recording apparatus of the present invention described above, the first computer program of the present invention can adopt various aspects.

The above object of the present invention can be also achieved by a second computer program for making the computer function as the above-mentioned information reproducing apparatus (including its various aspects). More specifically, the second computer program makes the computer function as at least one portion of the first reproducing device and the second reproducing device.

According to the second computer programs of the present invention, the above-mentioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the information reproducing apparatus of the present invention described above, the second computer program of the present invention can adopt various aspects.

The above object of the present invention can be also achieved by a first computer program product in a computer-readable medium for tangibly embodying a program of instructions executable by a computer, to make the computer function as at least one portion of the recording device, the selecting device, the generating device, and the controlling device of the above-mentioned information recording apparatus.

According to the first computer program product of the present invention, at least one portion of the recording device, the selecting device, the generating device, and the controlling device of the above-mentioned information recording apparatus of the above-described information recording apparatus can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the recording device, the selecting device, the generating device, and the controlling device of the above-mentioned information recording apparatus of the above-described information recording apparatus.

The above object of the present invention can be also achieved by a second computer program product in a computer-readable medium for tangibly embodying a program of instructions executable by a computer, to make the computer function as at least one portion of the first reproducing device and the second reproducing device of the above-mentioned information reproducing apparatus.

According to the second computer program product of the present invention, at least one portion of the first reproducing device and the second reproducing device of the above-mentioned information reproducing apparatus can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the first reproducing device and the second reproducing device of the above-mentioned information reproducing apparatus.

These effects and other advantages of the present invention will become more apparent from the following embodiment.

As explained above, according to the information recording apparatus, it is provided with: the recording device, the selecting device, the generating device, and the controlling device, and according to the information recording method, it is provided with: the selecting process, the generating process, and the controlling process. Therefore, it is possible to reduce the time length required for the finalize process, and as a result, it is possible to make the recording operation efficient and fast.

Moreover, according to the information reproducing apparatus, it is provided with: the first reproducing device and the second reproducing device, and according to the information reproducing method, it is provided with: the first reproducing process and the second reproducing process. Therefore, it is possible to properly reproduce the record information recorded on the information recording medium by the information recording apparatus of the present invention, with reference to the virtual reference information.

### BRIEF DESCRIPTION OF DRAWINGS

FIG. 1 are a substantial plan view showing the basic structure of an optical disc having a plurality of recording areas, associated with an information recording medium used in an embodiment of the information recording/reproducing apparatus of the present invention, and a schematic cross sectional view of the optical disc and a corresponding conceptual diagram showing a recording area structure in the radial direction.

FIG. 2 is a block diagram showing the information recording/reproducing apparatus in the embodiment of the information recording apparatus and the information reproducing apparatus of the present invention, and a host computer.

FIG. 3 is a flowchart conceptually showing a flow of the entire recording operation of the information recording/reproducing apparatus in the embodiment.

FIG. 4 is a flowchart conceptually showing a flow of the data alternate recording operation of the information recording/reproducing apparatus in the embodiment.

FIG. 5 are explanatory diagrams conceptually showing a flow of reproducing (or obtaining) a file with reference to a VAT, on the information recording/reproducing apparatus in the embodiment.

FIG. 6 are explanatory diagrams conceptually showing one specific example of the data structure of the optical disc on which the data is recorded by the information recording/reproducing apparatus in the embodiment, a corresponding disc volume space, and the VAT.

FIG. 7 are explanatory diagrams conceptually showing another specific example of the data structure of the optical disc on which the data is recorded by the information recording/reproducing apparatus in the embodiment, the corresponding disc volume space, and the VAT.

FIG. 8 are explanatory diagrams conceptually showing another specific example of the data structure of the optical disc on which the data is recorded by the information recording/reproducing apparatus in the embodiment, the corresponding disc volume space, and the VAT.

FIG. 9 are explanatory diagrams conceptually showing another specific example of the data structure of the optical disc on which the data is recorded by the information recording/reproducing apparatus in the embodiment, the corresponding disc volume space, and the VAT.

FIG. 10 are explanatory diagrams conceptually showing the disc volume space if the VAT is not referred to.

FIG. 11 is a data structure diagram conceptually showing the data structure on the optical disc 100 on which the data is recorded by an information recording/reproducing apparatus in a comparison example.

FIG. 12 is a data structure diagram conceptually showing the data structure on the optical disc 100 on which the data is recorded by the information recording/reproducing apparatus in the embodiment.

FIG. 13 is a flowchart conceptually showing a flow of the entire operation related to the modified operation example of the information recording/reproducing apparatus in the embodiment.

FIG. 14 are explanatory diagrams conceptually showing one specific example of the data structure and the volume space of the optical disc on which the data is recorded in the modified operation example.

FIG. 15 are explanatory diagrams conceptually showing another specific example of the data structure and the volume space of the optical disc on which the data is recorded in the modified operation example.

### DESCRIPTION OF REFERENCE CODES

100 Optical disc
102 Lead-in area
105 Data recording area
108 Lead-out area
109 Middle area
300 Information recording/reproducing apparatus
352 Optical pickup
353 Signal recording/reproducing device
354 CPU
355 Memory
359 CPU
360 Memory

### BEST MODE FOR CARRYING OUT THE INVENTION

Hereinafter, the best mode for carrying out the present invention will be discussed in order for each embodiment, with reference to the drawings.

The embodiment of the present invention will be explained hereinafter with reference to the drawings.

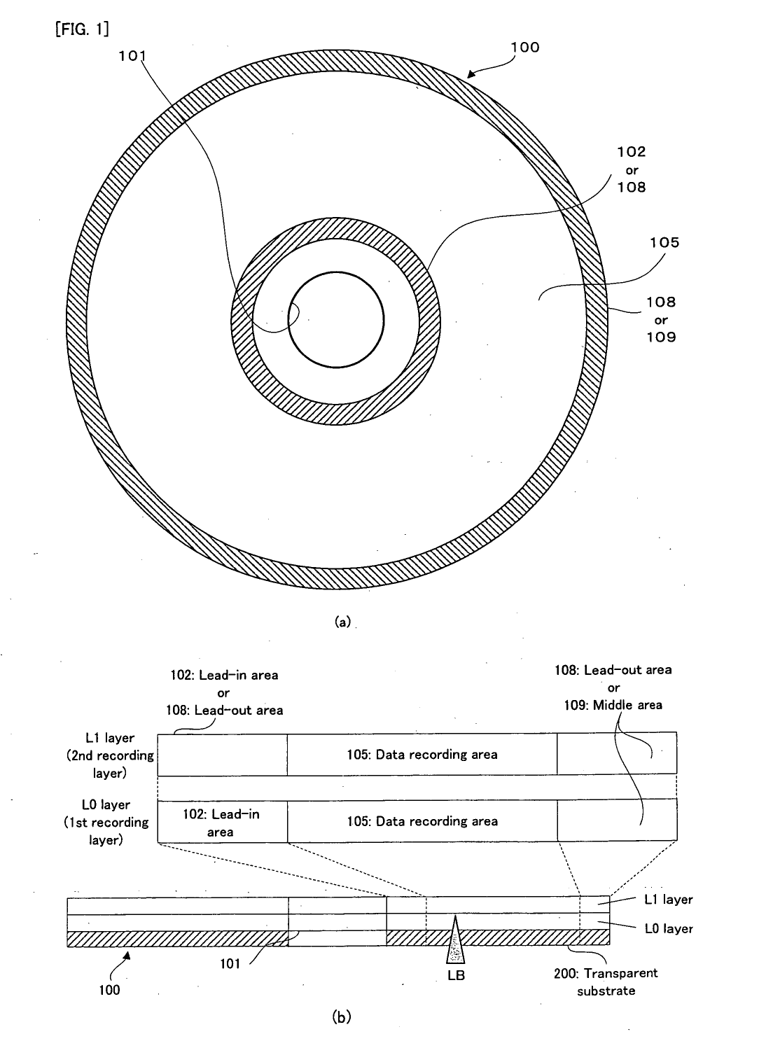

Firstly, with reference to FIG. 1, an explanation will be given for the basic structure of an optical disc associated with an information recording medium used in the embodiment of the information recording/reproducing apparatus of the present invention. FIG. 1(a) is a substantial plan view showing the basic structure of the optical disc having a plurality of recording areas, associated with the information recording medium used in the embodiment of the information recording/reproducing apparatus of the present invention, and FIG. 1(b) is a schematic cross sectional view of the optical disc and a corresponding conceptual diagram showing a recording area structure in the radial direction.

As shown in FIG. 1(a) and FIG. 1(b), an optical disc 100 has a recording surface on a disc main body with a diameter of about 12 cm, as is a DVD. On the recording surface, the optical disc 100 is provided with: a center hole 101 as the center; a lead-in area 102; a data recording area 105; and a lead-out area 108 or a middle area 109, which are associated with the embodiment. Then, for example, recording layers are laminated or stacked on a transparent substrate 200 of the optical disc 100. In each recording area of the recording layers, a recording track or tracks, such as a groove track and a land track, are alternately placed, spirally or concentrically, centered on the center hole 101. On the track, data is divided and recorded by a unit of ECC block. The ECC block is a data management unit by a pre-format address in which record information is error-correctable.

For example, in the case of the optical disc 100 which adopts an opposite track path type, in the L0 layer, there are provided the lead-in area 102, the data recording area 105, and the middle area 109, from the inner circumferential side. Moreover, in the L1 layer, there are provided the lead-out area 108, the data recording area 105, and the middle area 109, from the inner circumferential side. On the other hand, in the case of the optical disc 100 which adopts a parallel track path type, in the L0 layer, there are provided the lead-in area 102, the data recording area 105, and the lead-out area 108, from the inner circumferential side. Moreover, in the L1 layer, there are provided the lead-in area 102, the data recording area 105, and the lead-out area 108, from the inner circumferential side. Then, on the information recording/reproducing apparatus in the embodiment described later, data can be properly recorded onto the optical disc 100 which adopts any recording type, and it is possible to receive various benefits described later.

Incidentally, the present invention is not particularly limited to the optical disc having these three areas. For example, even if the lead-in area 102, the lead-out area 108 or the middle area 109 does not exist, a data structure explained below can be constructed. Moreover, as described later, the lead-in area 102, the lead-out area 108 or the middle area 109 may be further segmentized.

Particularly, the optical disc 100 in the embodiment, as shown in FIG. 1(b), has such a structure that a L0 layer and a L1 layer, which constitute one example of the “plurality of record layers” of the present invention described later, are laminated on the transparent substrate, for example. Upon the recording and reproduction of such a dual-layer type optical disc 100, the recording and reproduction in the L0 layer or the L1 layer is performed, depending on which recording layer has the focus position of laser light LB, irradiated from the lower side to upper side in FIG. 1(b). Moreover, the optical disc 100 in the embodiment is not limited to a two-layer single sided type, i.e., a dual layer type, but may be a two-layer double sided type, i.e., a dual layer double sided type. Furthermore, the optical disc 100 in the embodiment is not limited to the optical disc having the two recording layers, as described above, but may be an optical disc of a multilayer type which has three or more layers.

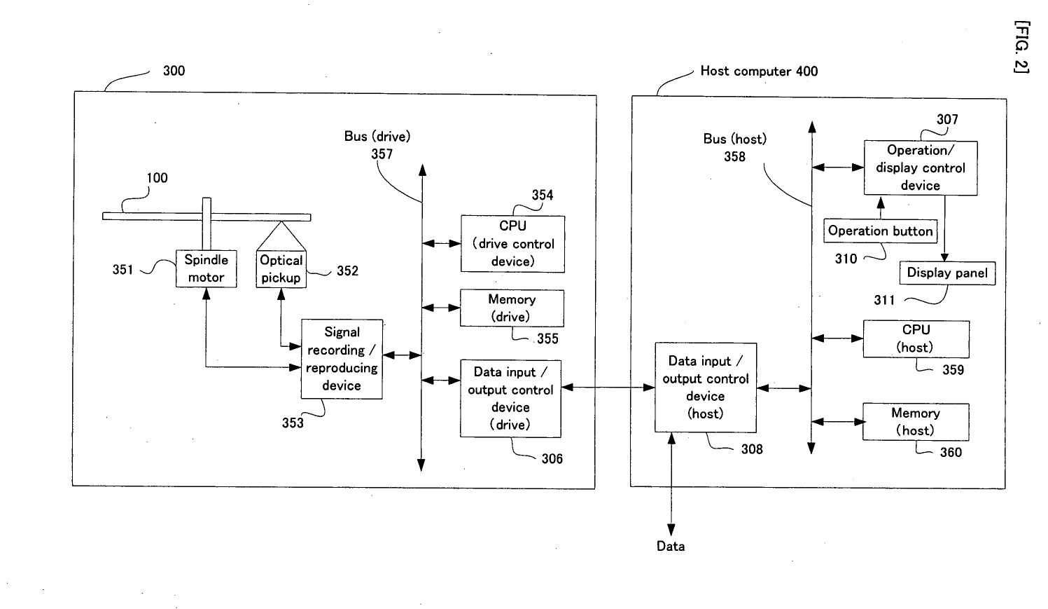

Next, with reference to FIG. 2 to FIG. 15, the embodiment of the information recording/reproducing apparatus of the present invention will be explained.

(Basic Structure)

Firstly, with reference to FIG. 2, an explanation will be given for the basic structure of an information recording/reproducing apparatus 300 in the embodiment of the information recording/reproducing apparatus of the present invention, and a host computer 400. FIG. 2 is a block diagram showing the information recording/reproducing apparatus in the embodiment of the information recording/reproducing apparatus of the present invention, and the host computer. Incidentally, the information recording/reproducing apparatus 300 has a function of recording the record data onto the optical disc 100 and a function of reading the record data recorded on the optical disc 100.

As shown in FIG. 2, the inner structure of the information recording/reproducing apparatus 300 will be explained. The information recording/reproducing apparatus 300 is an apparatus for recording information onto the optical disc 100 and for reading the information recorded on the optical disc 100, under the control of a CPU (Central Processing Unit) 354 for drive.

The information recording/reproducing apparatus 300 is provided with: the optical disc 100; a spindle motor 351; an optical pickup 352; a signal recording/reproducing device 353; the CPU (drive control device) 354; a memory 355; a data input/output device 306; and a bus 357. Moreover, the host computer 400 is provided with: a CPU 359; a memory 360; an operation/display control device 307; an operation button 310; a display panel 311; and a data input/output control device 308.

The spindle motor 351 is intended to rotate and stop the optical disc 100, and operates upon accessing the optical disc. More specifically, the spindle motor 351 is constructed to rotate the optical disc 100 at a predetermined speed and to stop it, under spindle servo from a not-illustrated servo unit or the like.

The optical pickup 352 is one specific example of the constituent element for realizing the “recording device”, the “first reproducing device”, and the “second reproducing device” of the present invention. The optical pickup 352 is provided with a semiconductor laser device, a lens, and the like, to perform the recording/reproduction with respect to the optical disc 100. More specifically, the optical pickup 352 irradiates the optical disc 100 with a light beam, such as a laser beam, as reading light with a first power upon reproduction, and as writing light with a second power upon recording, with it modulated.

The signal recording/reproducing device 353 is one specific example of the “recording device”, the “first reproducing device”, and the “second reproducing device” of the present invention. The signal recording/reproducing device 353 controls the spindle motor 351 and the optical pickup 352, to thereby perform the recording/reproduction with respect to the optical disc 100. More specifically, the signal recording/reproducing device 353 is provided with a laser diode (LD) driver, a head amplifier, and so on, for example. The LD driver drives a not-illustrated semiconductor laser located in the optical pickup 352. The head amplifier amplifies the output signal of the optical pickup 352, namely, the reflected light of a light beam, and outputs the amplified signal. More specifically, the signal recording/reproducing device 353 drives the not-illustrated semiconductor laser located in the optical pickup 352 in order to determine an optimum laser power by a recording process and reproduction process for the OPC pattern, along with a not-illustrated timing generator or the like, under the control of the CPU 354, at the time of OPC (Optimum Power Calibration) process.

The memory 355 is used in the general data processing and the OPC process on the information recording/reproducing apparatus 300, including a buffer area for the record/reproduction data, an area used as an intermediate buffer when data is converted into the data that can be used on the signal recording/reproducing device 353, and the like. Moreover, the memory 355 is provided with: a Read Only Memory (ROM) area into which a program for performing an operation as a recording device, namely, a firmware program is stored; a buffer for temporarily storing the record reproduction data; a Random Access Memory (RAM) area into which a parameter required for the operation of a firmware program or the like is stored; and the like.

The CPU (drive control device) 354 is connected to the signal recording/reproducing device 353 and the memory 355 via the bus 357, and controls the entire information recording/reproducing apparatus 300 by giving an instruction to various controlling devices. In general, software for operating the CPU 354 or firmware is stored in the memory 355.

The data input/output control device 306 controls the input/output of the data from the exterior with respect to the information recording/reproducing apparatus 300, to thereby perform storage to and export from the data buffer on the memory 355. A drive control order, issued from the external host computer 400 (hereinafter referred to as a host) which is connected with the information recording/reproducing apparatus 300 through an interface, such as a SCSI (Small Computer System Interface) and an ATAPI (AT Attachment Packet Interface), is transmitted to the CPU 354 through the data input/output control device 306. Moreover, the record/reproduction data is also exchanged with the host computer 400 through the data input/output control device 306 in the same manner.

The operation/display control device 307 receives an operation instruction and performs display with respect to the host computer 400, and transmits an instruction by the operation button 310, such as an instruction to record or reproduce, to the CPU 359. The CPU 359 transmits a control command to the information recording/reproducing apparatus 300 through the data input/output control device 308 on the basis of instruction information from the operation/display control device 307 and controls the entire information recording/reproducing apparatus 300. In the same manner, the CPU 359 can transmit a command to request the transmission of an operation state to the host, with respect to the information recording/reproducing apparatus 300. By this, the operation state of the information recording/reproducing apparatus 300, such as during recording and during reproduction, can be recognized, so that the CPU 359 can output the operation state of the information recording/reproducing apparatus 300 to the display panel 311, such as a fluorescent tube and a LCD, through the operation/display control device 307.

The memory 360 is an internal storage apparatus used by the host computer 400. The memory 360 is provided with: ROM area into which a firmware program, such as a BIOS (Basic Input/Output System), is stored; a RAM area into which parameters required for an operating system and the operation of an application program or the like are stored; and the like. Moreover, the memory 360 may be connected to an external storage apparatus, such as a not-illustrated hard disk, through the data input/output control device 308.

One specific example used by combining the information recording/reproducing apparatus 300 and the host computer 400, as explained above, is household equipment, such as recorder equipment for recording and reproducing video images. The recorder equipment records a video signal from a broadcast reception tuner and an external connection terminal, onto a disc, and outputs the video signal reproduced from the disc to external display equipment, such as a television. The operation as the recorder equipment is performed by executing a program stored in the memory 360. Moreover, in another specific example, the information recording/reproducing apparatus 300 is a disc drive (hereinafter referred to as a drive), and the host computer 400 is a personal computer or a work station. The host computer, such as a personal computer, and the drive are connected through the data input/output control devices 306 and 308, such as a SCSI and an ATAPI, and application, such as writing software, installed in the host computer 400 controls the disc drive.

(Operation Principle)

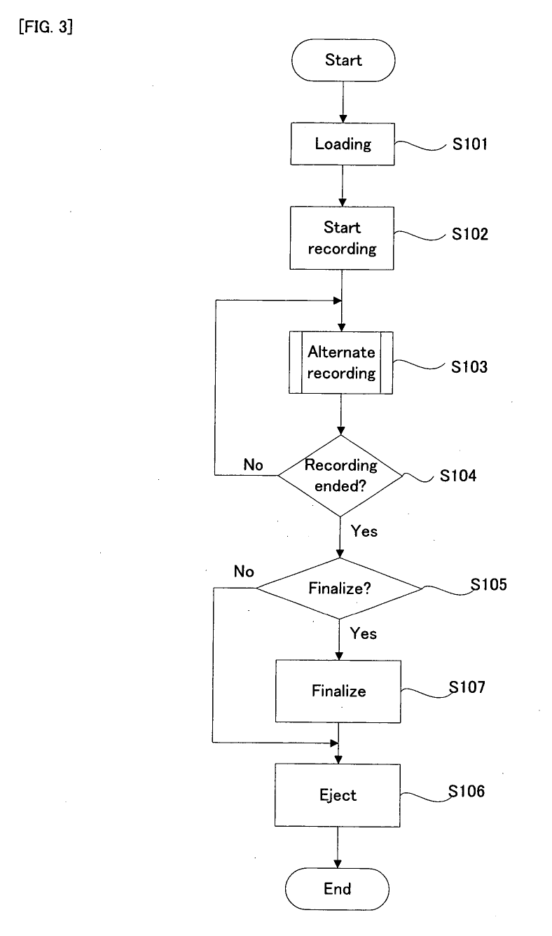

Next, with reference to FIG. 3 to FIG. 12, the operation principle of the information recording/reproducing apparatus 300 in the embodiment will be explained.

(1) Flow of Entire Recording Operation

Firstly, with reference to FIG. 3, the entire recording operation will be explained. FIG. 3 is a flowchart conceptually showing a flow of the entire recording operation of the information recording/reproducing apparatus in the embodiment.

As shown in FIG. 3, firstly, the optical disc 100 is loaded onto the information recording/reproducing apparatus 300 (step S101). Then, under the control of the CPU 354, for example, a seek operation is performed by the optical pickup 352, to thereby obtain various management data required for the recording process performed on the optical disc 100. On the basis of the management data, the recording operation of the data onto the optical disc 100 through the data input/output control device 308 is started, in response to an instruction from a user by using the operation button 310, for example, under the control of the CPU 354 or the CPU 359 (step S102).

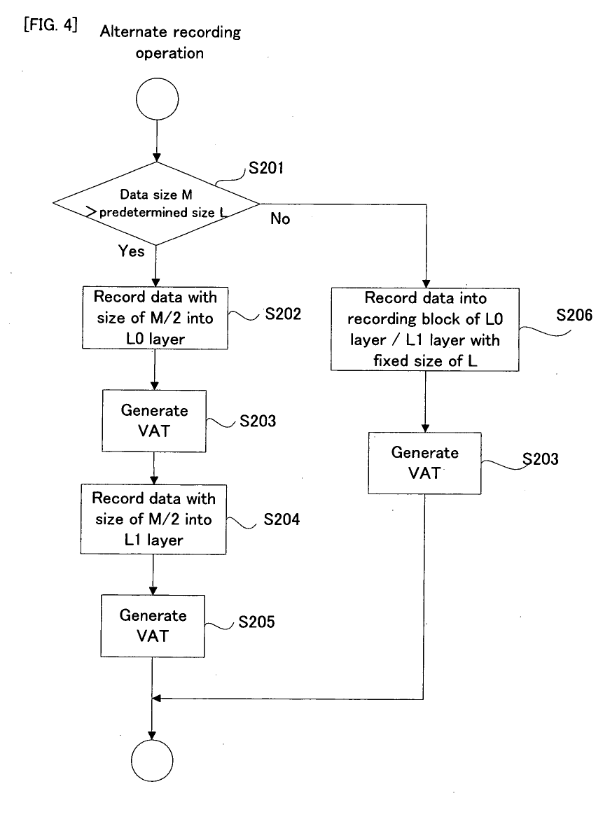

Particularly in the embodiment, the data including content data, such as video data, audio data, and PC data, is recorded into both the L0 layer and the L1 layer, alternately (or uniformly) (step S103). This alternate recording operation will be discussed in detail later (refer to FIG. 4, etc.).

After that, by the operation of the CPU 354, for example, it is judged whether or not the recording operation is ended (step S104). Namely, it is judged whether or not the recording of all the data to be recorded in the recording operation is ended.

As a result of the judgment, if it is judged that the recording operation is not ended (the step S104: No), the operational flow returns to the step S103 again, and the data to be recorded is further recorded. On the other hand, if it is judged that the recording operation is ended (the step S104: Yes), it is judged whether or not a finalize process is performed (step S105). As a result of the judgment, if it is judged that the finalizing is necessary (the step S105: Yes), the finalize process is performed (step S107). The finalize process is a process for making the information on the optical disc, recorded by the information recording/reproducing apparatus such as a DVD-R/RW recorder, reproducible on an information reproducing apparatus such as a DVD-ROM player, for example. More specifically, the finalize process is to generate the above-mentioned lead-in area 102, and lead-out area 108 or middle area 109, and to record dummy data therein, if needed.

Then, the optical disc 100 is ejected from the information recording/reproducing apparatus 300 (step S106), and the recording operation is ended.

(2) Flow of Alternate Recording Operation

Next, with reference to FIG. 4, the data alternate recording operation will be explained. FIG. 4 is a flowchart conceptually showing a flow of the data alternate recording operation.

As shown in FIG. 4, for example, under the control of the CPU 359, it is firstly judged whether or not the size M of the data to be recorded is larger than a predetermined fixed size L set in advance (step S201).

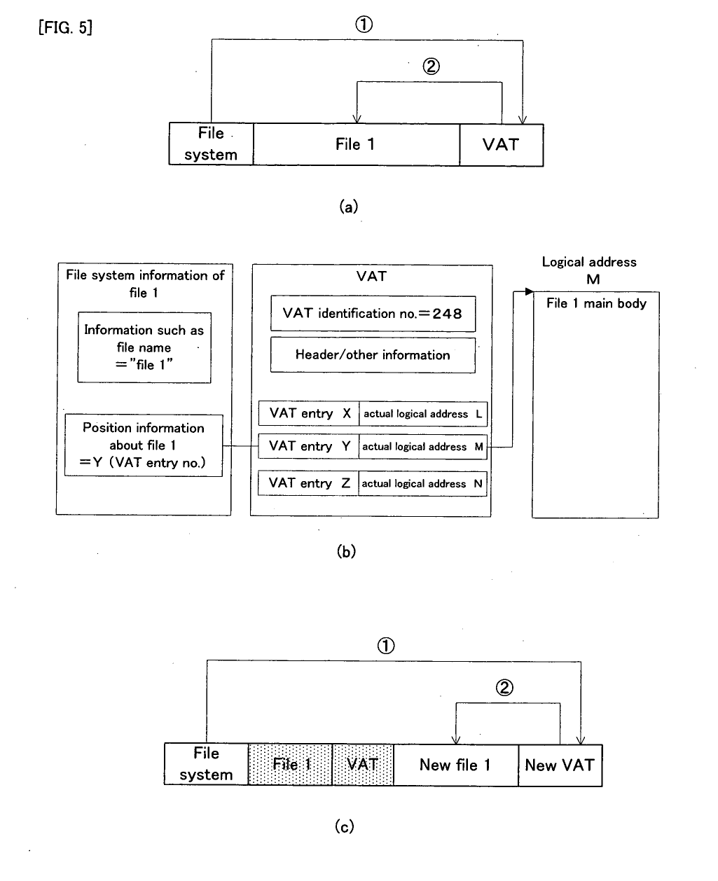

As a result of the judgment, if it is judged that the size M of the data to be recorded is larger than the predetermined fixed size L set in advance (the step S201: Yes), the data to be recorded is halved by the ECC block unit (i.e. divided into two data with a data size of about M/2), and the data with a data size of about M/2 is recorded firstly into the L0 layer (step S202). Then, under the control of the CPU 359, as one specific example of the “generating device” of the present invention, a VAT (Virtual Allocation Table) is generated, which is one specific example of the “virtual reference information” of the present invention (step S203). The VAT will be discussed in detail later (refer to FIG. 5, etc.). Then, the rest of the divided data, i.e. the data with a data size of about M/2, is recorded into the L1 layer (step S204). Then, the VAT is generated again (the step S203). In this case, it is assumed that one recording area into which the data is recorded is a recoding block, it can be said that this is a recording aspect of changing the data size of the recording block in accordance with the size of the data to be recorded (i.e. a variable-length recording aspect).

On the other hand, if it is judged that the size M of the data to be recorded is smaller than the predetermined fixed size L set in advance (the step S201: No), the data is recorded into one portion of the recording block having a data size of the fixed size L in the L0 layer or the L1 layer (step S206). Then, the VAT is generated (the step S203). At this time, if the data is recorded into the entire recording block having a data size of the fixed size L in the L0 layer, the data is newly recorded into the recording block having a data size of the fixed size L in the L1 layer, facing the recording block in the L0 layer. Namely, if there is a free space in the recording block in the L0 layer at the time point that the data is recorded, the data is recorded into the recording block in the L0 layer. On the other hand, if there is no free space in the recording block in the L0 layer, the data is recorded into the recording block in the L1 layer facing the recording block in the L0 layer. Moreover, if there is no free space in the recording block in the L1 layer, the data is recorded into another new recording block in the L0 layer located on the further outer circumferential side, and after that, this operation is repeated. In this case, it can be said that this is a recording aspect of fixing the data size of the recording block to the fixed size L (i.e. a fixed-length recording aspect).

As described above, by making the recording block variable-length or fixed-length, depending on the size of the data to be recorded, it is possible to record the data, more efficiently. Namely, if a relatively small size of data is recorded into the variable-length recording block, many fine (i.e. small size of) recording blocks are generated, so that it is not efficient. On the other hand, if a relatively large size of data is recorded into the fixed-length recording block, many divisional data are generated, so that it is not efficient. However, by performing the recording operation in accordance with the flowchart shown in FIG. 4, it is possible to prevent such a disadvantage, and it is possible to realize the efficient data recording.

Incidentally, it is obvious that the method of alternately recording the data into the L0 layer and the L1 layer, is not necessarily limited to the one explained with reference to FIG. 4. Namely, any recording method in which the data recorded into the L0 layer and the data recorded into the L1 layer have almost the same size, is included in the recording operation intended by the information recording/reproducing apparatus in the embodiment. Moreover, such alternate recording is performed, mainly under the control of the CPU 359 corresponding to one specific example of the “selecting device” of the present invention.

Next, the VAT will be explained with reference to FIG. 5. FIG. 5 are explanatory diagrams conceptually showing a flow of reproducing (or obtaining) a file, with reference to the VAT.

As shown in FIG. 5(a), when a file 1 recorded on the optical disc 100 is reproduced, firstly, the file system obtains the actual recording position of the file 1 to be reproduced, with reference to the VAT. Namely, the file system does not obtain the file 1 directly from position information about the file 1, but obtains the file 1 indirectly after once referring to the VAT.

Specifically, as shown in FIG. 5(b), file system information has file identification information, such as a file name, and information indicating the recording position where the file is recorded, for example. In particular, the information indicating the recording position of the file does not directly indicate a position where the entity of the file exists. The information indicating the recording position of the file is indirectly recorded as a VAT entry number (a virtual address) which refers to an address space virtually allocated. Here, as the identification information, such as the file name, there is recorded text information, which is the “file 1”. And, as indirect information indicating the recording position where the file 1 is recorded, there is recorded the entry number=“Y”. For example, in the file system which does not use the VAT, the file 1 is accessed by directly referring to the position information about the file 1 in the file information (in this case, by directly referring to Y), in FIG. 5(b).

The VAT has a VAT identification number, which is information indicating the identification number of the VAT itself, and information indicating a logical address (which is specifically a LBA (Logical Block Address) or LBN (Logical Block Number) and which is one specific example of the “logical address information” of the present invention) on a disc volume space (i.e. the logical address space of the present invention) corresponding to the VAT entry number. Here, for example, it has information indicating “248” as the VAT identification number, and a logical address value indicating the recording position corresponding to the VAT entry number=“Y”. Moreover, in the header information of the VAT, information about the recorded file, the number of directories or the like, and other information are also recorded.

Therefore, in referring to the file 1, it is possible to access the VAT on the basis of the information indicating the indirect recording position of the file 1 owned by the file system (the VAT entry number=“Y”), and refer to the VAT entry corresponding to the VAT entry number=“Y” on the VAT, and actually obtain the logical address value indicating the recording position of the file 1, and refer to the main body of the file 1.

Moreover, if the file 1 is newly rewritten, as shown in FIG. 5(c), the new file 1 is recorded into a new recording area of the data recording area 105, and a new VAT including the information indicating the recording position of the new file 1 is newly recorded. Then, referring of the new file 1 is performed by referring to the new VAT. Incidentally, the VAT is recorded into the recording area having the maximum logical address, out of the recording areas in which the data is recorded, in terms of the standard of UDF 2.00, for example. However, from the viewpoint that the information recording/reproducing apparatus in the embodiment properly operates, the VAT may be recorded in any position of the optical disc 100.

(3) Specific Data Recording Aspect and Data Reproducing Aspect

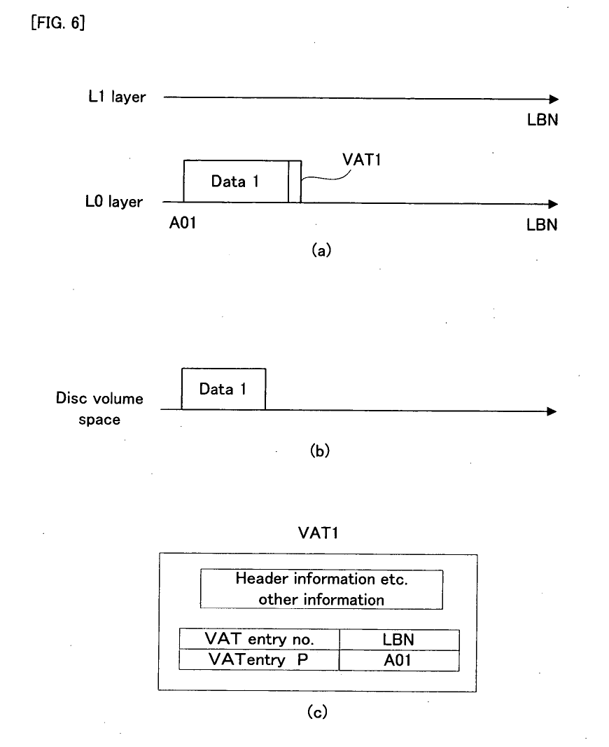

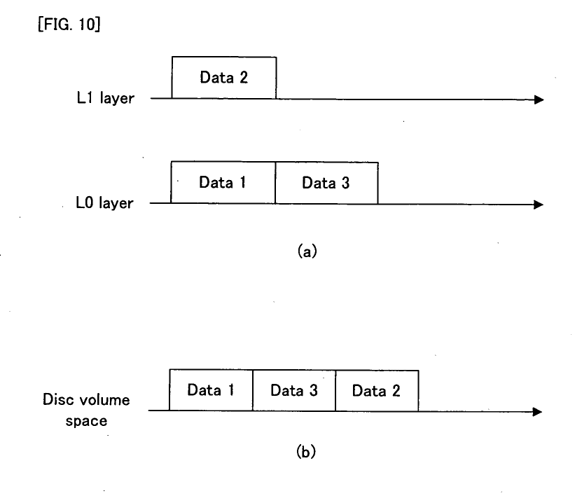

Next, with reference to FIG. 6 to FIG. 10, an explanation will be given for a specific aspect of recording the data, a correspondence relationship with the VAT, and an aspect of the reproducing the data by using the VAT. FIG. 6 to FIG. 9 are explanatory diagrams conceptually showing the data structure of the optical disc 100 on which the data is recorded, the corresponding disc volume space, and the VAT. FIG. 10 are explanatory diagrams conceptually showing the disc volume space if the VAT is not referred to. Incidentally, in FIG. 6 to FIG. 9, an explanation will be given for the aspect of recording the data onto the optical disc 100 of the parallel track path type. Moreover, in the explanation below, a relationship between the VAT and the data to be recorded will be mainly discussed. Thus, the explanation will be given, with the description relating to “AVDP (Anchor Volume Descriptor Pointer)” and “VDS (Volume Description Sequence)”, and “Root Directory ICB” or the like in the standard of UDF 2.00 omitted. Of course, in order to comply with the standard of UDF 2.00, the data is obviously recorded, as explained later, while the various file system information is also recorded.

As shown in FIG. 6(a), firstly, data 1 is recorded into the recording area in the L0 layer whose logical address value on the disc volume space is expressed by “A01”. Then, under the control of the CPU 359, as one specific example of the “controlling device” of the present invention, a VAT 1 is recorded, into the recording area following the recording area having the maximum logical address out of the recording areas in which the data is recorded, i.e. into the last recording area of the data recording area 105 in the L0 layer.

At this time, the data 1 is disposed, as shown in FIG. 6(a), in the disc volume space of the optical disc 100, recognized by the information recording/reproducing apparatus 300.

Moreover, the VAT 1 includes information indicating a correspondence between the VAT entry number corresponding to the data 1 and the logical address of the data 1 on the disc volume space. Specifically, as shown in FIG. 6(c), a table on which the VAT entry number “P” corresponding to the data 1 is associated with the logical address of the data 1 (LBN=“A01”), is recorded as the VAT 1 onto the optical disc 100.

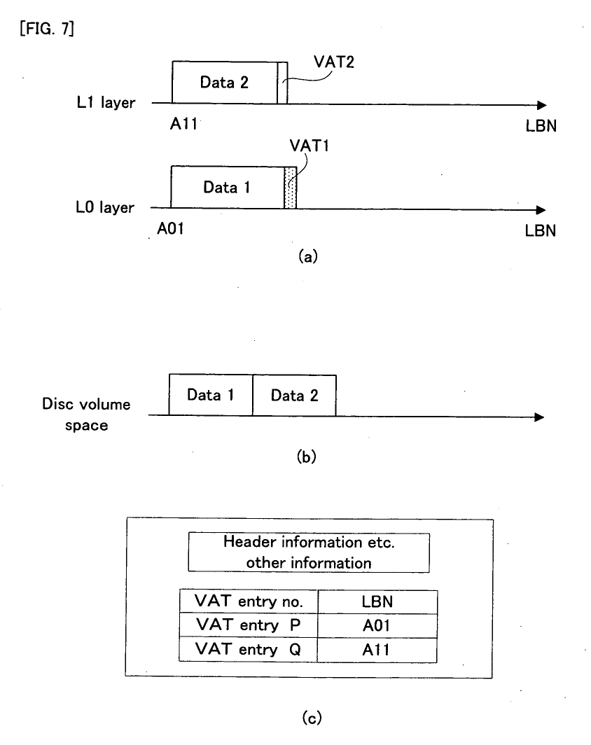

Then, as shown in FIG. 7(a), it is assumed that data 2 is recorded into the recording area in the L1 layer whose logical address value on the volume space is expressed by “A11”. The address “A11” is an address value next to the last logical address value of the record data of the data 1. At this time, a VAT 2 is newly generated, and the VAT 2 is recorded into the recording area following the recording area having the maximum logical address on the disc volume space, out of the recording areas in which the data is recorded, i.e. into the recording area following the data 2 recorded in the L1 layer. At this time, the information recording/reproducing apparatus 300 or the like performs the data recording or reproduction operation, with reference to the VAT 2, which is the newest VAT. Namely, at the time that the VAT 2 is newly recorded, the VAT1 is not referred to by the information recording/reproducing apparatus 300 or the like.

At this time, in the disc volume space of the optical disc 100 recognized by the information recording/reproducing apparatus 300 or the like, the data 1 and the data 2 are disposed, as shown in FIG. 7(b). The reason why the information recording/reproducing apparatus 300 recognizes that the data 1 and the data 2 are disposed in series in the disc volume space, and the reason why it recognizes that the size of the disc volume space, which is constructed only from the data 1 in the beginning, becomes large, are that it is constructed to access each data by referring to the VAT 2 explained below.

The VAT 2 includes information indicating a correspondence between the VAT entry numbers corresponding to each of the data 1 and the data 2, and the logical addresses on the disc volume space of respective one of the data 1 and the data 2. Specifically, as shown in FIG. 7(c), in addition to the information about the data 1 owned by the VAT 1 shown in FIG. 6, a table on which the VAT entry number “Q” corresponding to the data 2 is associated with the logical address (LBN=“A11”) of the data 2, is recorded onto the optical disc 100 as the VAT 2.

Then, in actually accessing (or reproducing) the data 1 and the data 2, firstly, the VAT 2 is referred to from the file system. For example, in order to access the data 1, virtual position information about the data 1, i.e. the VAT entry number=“P”, is obtained from the file system. The logical address value (LBN=“A01”) corresponding to the VAT entry number=“P” is obtained from the VAT, to thereby access the actual data 1. Moreover, in order to access the data 2, virtual position information about the data 2, i.e. the VAT entry number=“Q”, is obtained from the file system. The logical address value (LBN=“A11”) corresponding to the VAT entry number=“Q” is obtained from the VAT, to thereby access the actual data 2. Therefore, if the data is accessed in accordance with the order of the VAT entry number, it is possible to access each data in the order of recording the data onto the optical disc 100. It can be said that the VAT entry number is information indirectly indicating the recording order of the data.

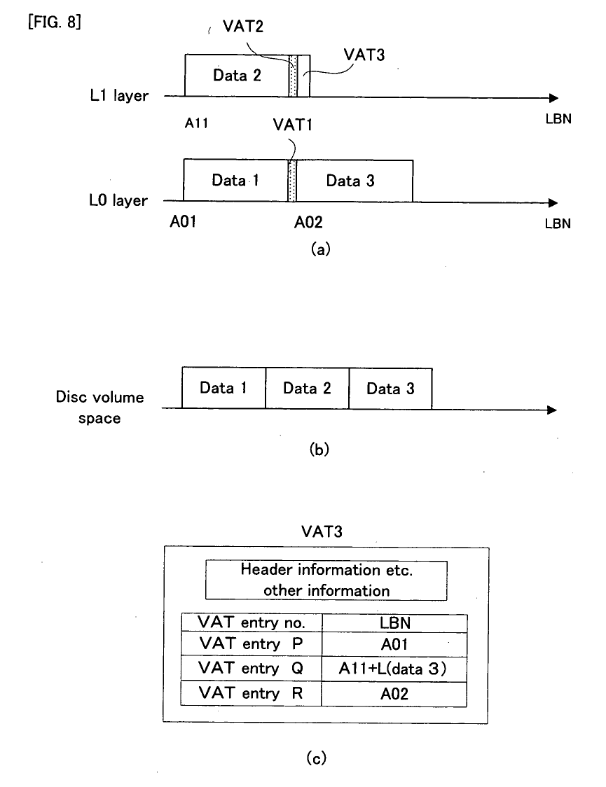

Then, as shown in FIG. 8(a), it is assumed that data 3 is recorded into the recording area in the L0 layer whose logical address value on the volume space is expressed by “A02” (i.e. the recording area continued from the recording area in which the data 1 is recorded). At this time, a VAT 3 is newly generated, and the VAT 3 is recorded into the recording area following the recording area having the maximum logical address on the disc volume space, out of the recording areas in which the data is recorded, i.e. into the recording area following the VAT 2 recorded in the L1 layer. At this time, the information recording/reproducing apparatus 300 or the like performs the data recording or reproduction operation, with reference to the VAT 3, which is the newest VAT. Namely, at the time that the VAT 3 is newly recorded, the VAT1 and the VAT2 are not referred to by the information recording/reproducing apparatus 300 or the like.

At this time, in the disc volume space of the optical disc 100 recognized by the information recording/reproducing apparatus 300 or the like, the data 1, the data 2, and the data 3 are disposed in this order, as shown in FIG. 8(b). Namely, each data is disposed on the volume space of the optical disc 100, in accordance with the recording order of the data. The reason why the information recording/reproducing apparatus 300 recognizes that the data 1, the data 2, and the data 3 are disposed in series in the recording order on the disc volume space is that it is constructed to access each data by referring to the VAT 3.

The VAT 3 includes information indicating a correspondence between the VAT entry numbers corresponding to each of the data 1, the data 2, and the data 3, and the logical addresses on the disc volume space of respective one of the data 1, the data 2, and the data 3. Specifically, as shown in FIG. 8(c), in addition to the information about the data 1 and the data 2 owned by the VAT 2 shown in FIG. 7, a table on which the VAT entry number “R” corresponding to the data 3 is associated with the logical address (LBN=“A02”) of the data 3, is recorded onto the optical disc 100 as the VAT 3.

In particular, in the VAT 3, the logical address value of the data 2 on the disc volume space is changed, as compared to the VAT 2. This is caused by that the disc volume space is constructed generally by allocating all the recording areas in the L1 layer following all the recording areas in the L0 layer. Namely, at the time point that the data 3 is recorded, the data is disposed in the order of the data 1, the data 3 and the data 2, as shown in FIG. 10, in the disc volume space of the optical disc 100. Namely, the data 3 is disposed before the data 2, so that the logical address of the data 2 on the disc volume space is changed. Specifically, the logical address of the data 2 on the disc volume space increases just by the address value corresponding to the data length of the data 3. As described above, if the logical address of the data in the middle of the recording operation is changed, there is a possibility that the data having the changed logical address cannot be properly accessed. Namely, if the data is directly accessed from the file system without using the VAT, as described above, it is necessary that the file system directly specifies the logical address or the like that the data actually exists. However, in the file system, it is impossible to rewrite the file system information by overwriting, in the case of write-once media. Moreover, if the file system information is rewritten by additional recording, it is necessary to write all the file system information again, which is a waste of recording capacity.

If the VAT is not used and all the file system information is not updated by additional recording, with regard to the data whose logical address is changed as in the above-mentioned data 2, there is a possibility that the logical address of the data 2 before the change is likely specified in order to access the data 2. Thus, there is a possibility that it is hardly possible to properly access the data 2. Namely, on the disc volume space recognized by the information recording/reproducing apparatus 300, there is a possibility that it is hardly possible to recognize the recording position of the data and access the data.

In the embodiment, however, it is possible to ensure the proper access to each data to be recorded, by accessing the data via the VAT and rewriting (or newly generating) the VAT every time the logical address of the data to be recorded is changed (or every time the data is newly recorded). Specifically explaining this by using FIG. 8, for example, the logical address value of the data 2 included in the VAT 3 is changed. Namely, the logical address value of the data 2 is increased just by the address value corresponding to the data length of the data 3, owing to the recording of the data 3. Therefore, if the size converted to the address value of the data size of the data 3 is L (data 3), the logical address of the data 2 is LBN=A01+L (data 3), on the VAT 3.

Incidentally, in an example of use of the VAT described in the background art documents or the like, it is used to maintain consistency between the old file and the new rewritten file (i.e. to properly access the new file), mainly when the file is rewritten. In the embodiment, however, it is used to change the arrangement of each data on the disc volume space if needed, or change the size of the entire disc volume space if needed. Namely, the information recording/reproducing apparatus in the embodiment uses the VAT from a viewpoint totally different from the use of the VAT listed in the background art documents or the like. And because the VAT is used in this manner, it is possible to ensure the proper recording of the like of the data onto the optical disc having the plurality of recording layers.

Then, actually in accessing (or reproducing) the data 1, the data 2, and the data 3, firstly, the VAT 3 is referred to from the file system. For example, in order to access the data 1, the virtual position information about the data 1, i.e. the VAT entry number=“P”, is obtained from the file system. The logical address value (LBN=“A01”) corresponding to the VAT entry number=“P” is obtained from the VAT, to thereby access the actual data 1.

Moreover, in order to access the data 2, the VAT entry number=“Q” of the data 2 is obtained from the file system. The logical address value (LBN=“A11+L (data 3)”) corresponding to the VAT entry number=“Q” is obtained from the VAT, to thereby access the actual data 2. If it is desired to access the data 2 directly from the file system without reference to the VAT 3, for example, LBN=“A11” is specified to thereby access the data 2, so that the position of the original data 2 cannot be accessed and some recording portion of the data 3 is likely accessed, for example. In the embodiment, however, the data 2 is accessed with reference to the newly generated VAT 3, so that even if the logical address value on the disc volume space of the data 2 is changed due to the addition of the data 3, it is possible to properly access the data 2.

Moreover, in order to access the data 3, the VAT entry number=“R” of the data 3 is obtained from the file system. Then, the logical address value (LBN=“A02”) corresponding to the VAT entry number=“R” is obtained from the VAT, to thereby access the actual data 3.

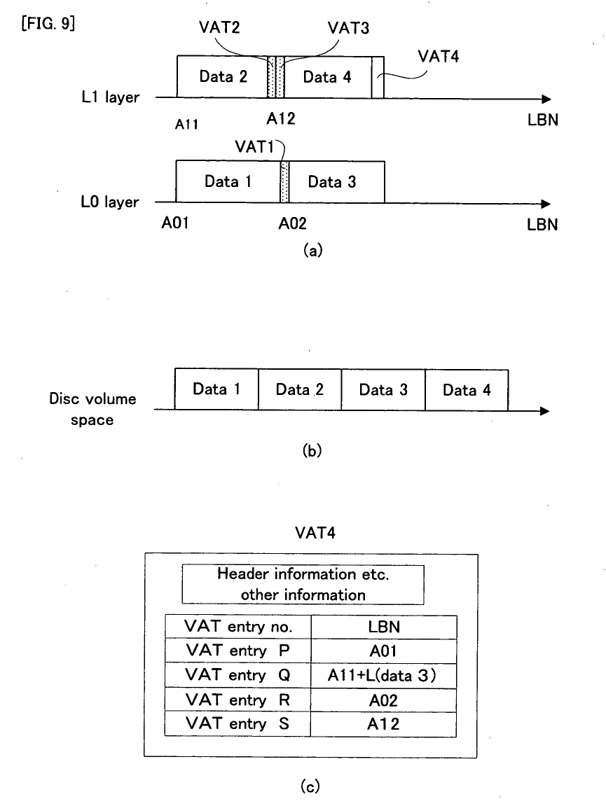

Moreover, as shown in FIG. 9(a), it is assumed that data 4 is recorded into the recording area of the L1 layer whose logical address value on the volume space is expressed by “A12” (i.e. the recording area continued from the recording area in which the VAT 3 is recorded). At this time, a VAT 4 is newly generated, and the VAT 4 is recorded into the recording area following the recording area having the maximum logical address on the disc volume space, out of the recording areas in which the data is recorded, i.e. into the recording area following the data 4 recorded in the L1 layer. Even at this time, the information recording/reproducing apparatus 300 or the like performs the data recording or reproduction operation, with reference to the VAT 4, which is the newest VAT. Namely, at the time that the VAT 4 is newly recorded, the VAT1, the VAT 2, and the VAT 3 are not referred to by the information recording/reproducing apparatus 300 or the like.

At this time, in the disc volume space of the optical disc 100 recognized by the information recording/reproducing apparatus 300 or the like, the data 1, the data 2, the data 3, and the data 4 are disposed in this order, as shown in FIG. 9(b). Namely, each data is disposed on the volume space of the optical disc 100, in accordance with the recording order of the data.

The VAT 4 includes information indicating a correspondence between the VAT entry numbers corresponding to each of the data 1, the data 2, the data 3, and the data 4, and the logical addresses on the disc volume space of respective one of the data 1, the data 2, the data 3, and the data 4. Specifically, as shown in FIG. 9(c), in addition to the information about the data 1, the data 2, and the data 3 owned by the VAT 3 shown in FIG. 8, a table on which the VAT entry number “S” corresponding to the data 4 is associated with the recording position (LBN=“A12”) of the data 4, is recorded onto the optical disc 100 as the VAT 4.

Incidentally, the additional recording of the data 4 does not change the logical address on the disc volume space of each of the data 1, the data 2, and the data 3, so that the information (particularly, LBN) included in the VAT 4 about the data 1, the data 2 and the data 3 is the same as those included in the VAT 3.

Then, in actually accessing (or reproducing) the data 1, the data 2, the data 3, and the data 4, firstly, the VAT 4 is referred to from the file system. For example, in order to access the data 1, the VAT entry number=“P” corresponding to the data 1 is obtained from the file system. Then, the logical address value (LBN=“A01”) corresponding to the VAT entry number=“P” is obtained from the VAT, to thereby access the actual data 1. Moreover, in order to access the data 2, the VAT entry number=“Q” corresponding to the data 2 is obtained from the file system. Then, the logical address value (LBN=“A11+L (data 3)”) corresponding to the VAT entry number=“Q” is obtained from the VAT, to thereby access the actual data 2. Moreover, in order to access the data 3, the VAT entry number=“R” corresponding to the data 3 is obtained from the file system. Then, the logical address value (LBN=“A02”) corresponding to the VAT entry number=“R” is obtained from the VAT, to thereby access the actual data 3. Moreover, in order to access the data 4, the VAT entry number=“S” corresponding to the data 4 is obtained from the file system. Then, the logical address value (LBN=“A12”) corresponding to the VAT entry number=“S” is obtained from the VAT, to thereby access the actual data 4. Therefore, if it is constructed to access the data in the ascending order of the VAT entry number, for example, the information recording/reproducing apparatus 300 can access each data in the recording order of the data. Namely, with reference to the VAT 4, the information recording/reproducing apparatus 300 recognizes that each data is disposed in the recording order of the data, as shown in FIG. 9(b), on the disc volume space.

As described above, by accessing the data recorded on the optical disc 100 via the VAT, even if the logical address value on the disc volume space of each data is changed by the alternate recording operation onto the dual-layer type optical disc, it is possible to properly record the data and reproduce the recorded data.

Moreover, the data recorded on the optical disc 100 can be accessed via the VAT, so that it is possible to divide a title, such as one movie data, or a file, such as one PC data, into a plurality of data having a relatively small data size, and record them into each of the L0 layer and the L1 layer. As described above, if the data is not accessed via the VAT, it is impossible to properly access each of the plurality of divided data, even if the file name or title name or the like is directly specified from the file system. Even in this regard, the information recording/reproducing apparatus in the embodiment has a great advantage.

Moreover, it is constructed such that the data is recorded alternately into the L0 layer and the L1 layer and to substantially equalize the sizes of the recording areas in which the data is already recorded in both the L0 layer and the L1 layer. By this, there is such an advantage that in the finalize process performed on the optical disc, a time length required for the process becomes relatively short.

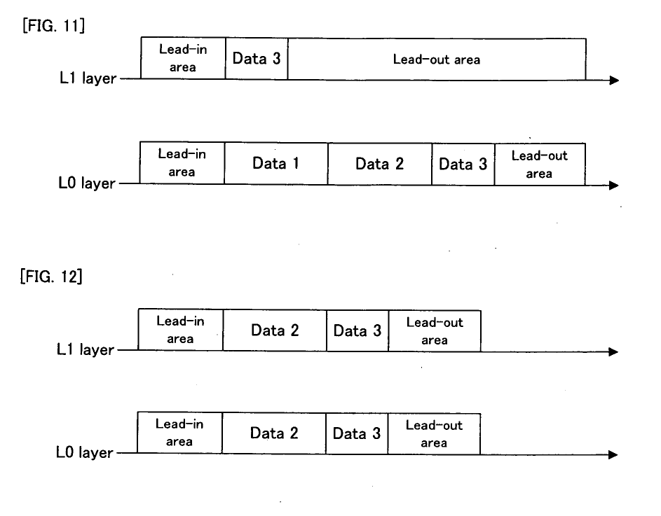

This will be specifically explained with reference to FIG. 11 and FIG. 12. FIG. 11 is a data structure diagram conceptually showing the data structure on the optical disc 100 on which the data is recorded by an information recording/reproducing apparatus in a comparison example. FIG. 12 is a data structure diagram conceptually showing the data structure on the optical disc 100 on which the data is recorded by the information recording/reproducing apparatus in the embodiment.

As shown in FIG. 11, in the case of the optical disc on which the data is recorded by the information recording/reproducing apparatus in the comparison example, in which the data is recorded into the L1 layer after the data is recorded into the entire L0 layer, the data 1, the data 2, and one portion of the data 3 are recorded into the data recording area 105 in the L0 layer and there is no more free space. Here, the data 1, the data 2, and the data 3 have substantially the same data size. Then, the rest of the data 3 is recorded into the L1 layer. At this time, it is necessary to perform the finalize process on the optical disc 100 in order to provide compatibility with a read-only (reproduce-only) information recording medium. Specifically, the lead-in area 102 and the lead-out area 108 are provided, and moreover, in order to prevent the optical disc 100 from being out of control, it is necessary to record dummy data, which constitutes one portion of the lead-out area 108, into the recording area in the L0 layer in which the data is already recorded. In the data recording aspect shown in FIG. 11, the data is recorded in the entire L0 layer and the data is hardly recorded in the L1 layer, so that it is necessary to record the dummy data in a wide range in the L1 layer, which is a problem of greatly increasing the time length required for the finalize process.

On the other hand, as shown in FIG. 12, in the case of the optical disc on which the data is recorded by the information recording/reproducing apparatus 300 in the embodiment, the data is recorded alternately into both the L0 layer and the L1 layer and to substantially equalize the sizes of the recording areas in which the data is already recorded in both the L0 layer and the L1 layer. Specifically, the data 1 is recorded into the L0 layer, and the data 2 with substantially the same data size as that of the data 1 is recorded into the L1 layer. The data 3 is divided and recorded into both the L0 layer and the L1 layer. Therefore, the data is already recorded in the L1 layer corresponding to the L0 layer in which the data is already recorded, so that in the finalize process, it is only necessary to generate the lead-in area 102 and the lead-out area 108, and it is hardly necessary to record the dummy data into the L1 layer, as described above. In other words, on the outer circumferential side of the lead-out area 108, an unrecorded condition (i.e. a mirror condition) will do. Thus, the time length required for the finalize process can be reduced, by which it is possible to contribute to the reduction of the recording operation time and the improvement of a user's comfort, or the like.

Incidentally, in the above-mentioned embodiment, the dual-layer type optical disc is explained as one example of the information recording medium; however, of course, the present invention is not necessarily limited to this, and even an information recording medium having three or more recording layers can receive the above-mentioned various benefits by adopting the same structure.

Moreover, even in the case of an optical disc having one recording layer, it is possible to properly record the data and reproduce the recorded data by managing the data using the VAT as described above, even if the data is randomly recorded onto the optical disc, for example.

Moreover, in the above-mentioned embodiment, the optical disc in the parallel track path type is explained as one example; however, of course, even the optical disc in the opposite track path type and an optical disc in another recording path type can receive the above-mentioned various benefits by properly managing the data using the VAT.

Moreover, in the case of a multi-border type information recording/reproducing apparatus, it is also possible to provide a border-in area, a border-out area, and a layer buffer area, as occasion demands, in recording the data over the L0 layer and the L1 layer.

### MODIFIED EXAMPLE

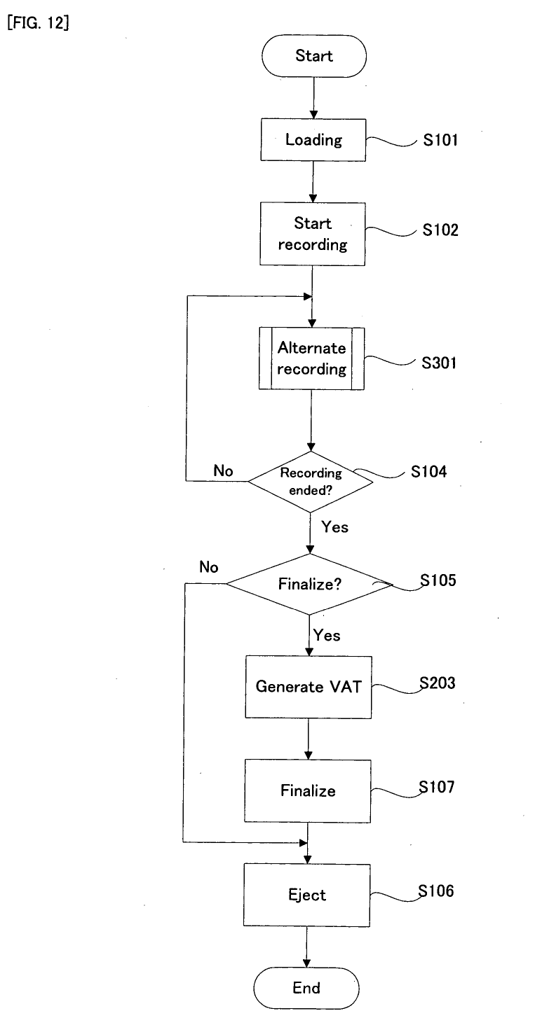

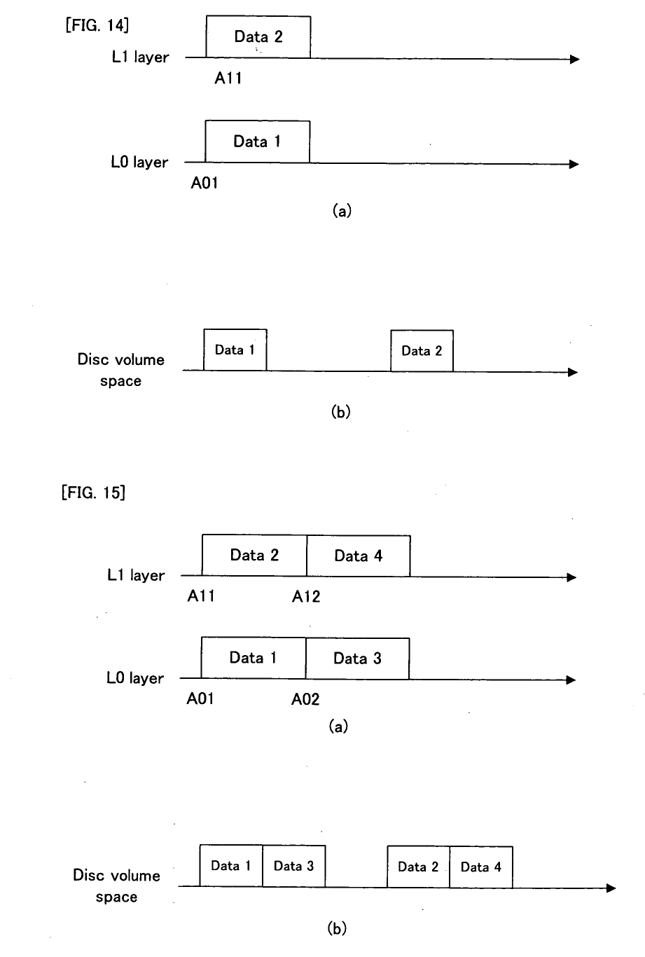

Next, with reference to FIG. 13 to FIG. 15, the modified operation example of the information recording/reproducing apparatus in the embodiment will be explained. FIG. 13 is a flowchart conceptually showing a flow of the entire operation related to the modified operation example. FIG. 14 and FIG. 15 are explanatory diagrams conceptually showing the data structure and the volume space of the optical disc on which the data is recorded in the modified operation example.

As shown in FIG. 13, even in the modified example, as described above by using FIG. 3 or the like, after the optical disc is loaded (the step S101), the recording operation is started (the step S102).

Particularly in the modified example, the alternate recording operation is performed without generating the VAT explained in FIG. 4 (step S301). Namely, the alternate recording operation is performed without generating the VAT every time the data is recorded into some recording layer.

At this time, in order to properly manage the data recorded onto the optical disc 100 on the information recording/reproducing apparatus 300, it is preferable to generate the information for data management and record it onto the memory 355 (or the memory 360), for example.

Then, it is judged whether or not the recording operation is ended (the step S104). If it is judged that the recording operation is ended (the step S104: Yes), the VAT is generated (the step S203), and the finalize process is performed, and the lead-in area and the lead-out area are recorded (the step S107).

Specifically, the VAT is generated to maintain the consistency on the disc volume space of the data recorded on the optical disc 100.

For example, in the case where the data 1 and the data 2 are recorded on the optical disc 100 as shown in FIG. 14(a), if the VAT is not generated, the data 1 and the data 2 on the disc volume space recognized by the information recording/reproducing apparatus 300 in the embodiment are disposed as shown in FIG. 14(b). At this time, if the finalize process is performed and the VAT is generated, the data 1 and the data 2 on the disc volume space recognized by the information recording/reproducing apparatus 300 in the embodiment are disposed as explained in FIG. 7(b). Namely, the disc volume space in which the data 1 and the data 2 are continuously disposed is constructed. Then, the VAT generated here is the same table as the VAT 2 shown in FIG. 7(c).

Moreover, as shown in FIG. 15(a), in the case where the data 1, the data 2, the data 3, and the data 4 are recorded on the optical disc 100, if the VAT is not generated, the data 1, the data 2, the data 3, and the data 4 on the disc volume space recognized by the information recording/reproducing apparatus 300 in the embodiment are disposed as shown in FIG. 15(b). At this time, if the finalize process is performed and the VAT is generated, the data 1, the data 2, the data 3, and the data 4 on the disc volume space recognized by the information recording/reproducing apparatus 300 in the embodiment are disposed as explained in FIG. 9(b). Namely, the disc volume space in which the data 1, the data 2, the data 3, and the data 4 are continuously disposed is constructed. Then, the VAT generated here is the same table as the VAT 4 shown in FIG. 9 (c).

As described above, even if it is constructed to generate the VAT in the finalize process, for example, it is possible to properly reproduce the data with reference to the VAT, when the data recorded on the optical disc 100 is reproduced by the information recording/reproducing apparatus 300. Moreover, it is not necessary to record the VAT onto the optical disc 100 during the recording operation, so that it is possible to effectively use the recording capacity of the optical disc 100.

Incidentally, in this case, it may be constructed such that the once generated VAT becomes the condition of not capable of effectively being used, under the control of the CPU 354 or the CPU 359. For example, it may be constructed such that the once generated VAT can be logically deleted_from the optical disc 100. Alternatively, it may be constructed such that the VAT is not referred to on the information recording/reproducing apparatus 300. By virtue of such construction, it is possible to change the arrangement of each data on the disc volume space recognized by the information recording/reproducing apparatus 300, between the condition shown in FIG. 14(b) or FIG. 15(b) and the condition shown in FIG. 7(c) or FIG. 9(c). Then, it is also possible to reconstruct the arrangement of the data on the volume space, for example. Then, it is also possible to further add the data onto the optical disc 100 on which the VAT is generated once, relatively easily.

Incidentally, the VAT is not necessarily generated in the finalize process, but the VAT may be generated, as occasion demands, if needed, in the middle of the recording operation, for example, or the VAT may not be able to be used effectively, as occasion demands, if needed.

Moreover, in the above-mentioned embodiment, the optical disc 100 is explained as one example of the information recording medium, and the recorder or the player associated with the optical disc 100 is explained as one example of the information recording/reproducing apparatus. The present invention, however, is not limited to the optical disc and the recorder thereof, and can be applied to other various information recording media which support high-density recording or high-transfer rate, and the recorder or player thereof.

The present invention is not limited to the above-described embodiment, and various changes may be made, if desired, without departing from the essence or spirit of the invention which can be read from the claims and the entire specification. An information recording apparatus, an information recording method, an information reproducing apparatus, an information reproducing method, and a computer program for recording control, all of which involve such changes, are also intended to be within the technical scope of the present invention.

### INDUSTRIAL APPLICABILITY

The information recording apparatus, the information recording method, the information reproducing apparatus, the information reproducing method, and the computer program according to the present invention can be applied to an information recording apparatus, such as a DVD recorder, and can be applied to an information reproducing apparatus, such as a DVD player. Moreover, they can be applied to an information recording/reproducing apparatus or the like which is mounted on various computer equipment for consumer use or for business use, or which can be connected to various computer equipment.

1. An information recording apparatus comprising:
a recording device capable of recording record information onto an information recording medium having a plurality of recording layers;
a selecting device for sequentially selecting one recording layer to record therein the record information, such that a recording area of the record information recorded into each of the plurality of recording layers substantially uniformly expands, in accordance with the recording of the record information;
a generating device for generating virtual reference information (i) including logical address information on the information recording medium corresponding to the record information on a logical address space and (ii) associating the recording order of the record information with the logical address information corresponding to the recording position such that a recording position of the record information on the logical address space of the information recording medium is placed in a recording order of the record information onto the information recording medium; and
a controlling device for controlling said recording device to record the generated virtual reference information onto the information recording medium,
if the record information being newly recorded, said generating device generating the virtual reference information by rewriting the logical address information corresponding to at least the record information whose logical address information is changed due to the newly recording of the record information, out of the record information recorded on the information recording medium.

2-3. (canceled)

4. The information recording apparatus according to claim 1, wherein said generating device generates the virtual reference information every time the record information is newly recorded into the selected one recording layer.

5. The information recording apparatus according to claim 1, wherein said generating device generates the virtual reference information if the information recording medium is finalized.

6. The information recording apparatus according to claim 1, further comprising a negating device for negating the generated virtual reference information.

7. An information recording method in an information recording apparatus comprising: a recording device capable of recording record information onto an information recording medium having a plurality of recording layers,
said information recording method comprising:
a selecting process of sequentially selecting one recording layer to record therein the record information, such that a recording area of the record information recorded into each of the plurality of recording layers substantially uniformly expands, in accordance with the recording of the record information;
a generating process of generating virtual reference information (i) including logical address information on the information recording medium corresponding to the record information on a logical address space and (ii) associating the recording order of the record information with the logical address information corresponding to the recording position such that a recording position of the record information on the logical address space of the information recording medium is placed in a recording order of the record information onto the information recording medium; and
a controlling process of controlling said recording device to record the generated virtual reference information onto the information recording medium,
if the record information being newly recorded, said generating process generating the virtual reference information by rewriting the logical address information corresponding to at least the record information whose logical address information is changed due to the newly recording of the record information, out of the record information recorded on the information recording medium.

8. An information reproducing apparatus for reproducing the record information recorded on the information recording medium by the information recording apparatus comprising: a recording device capable of recording record information onto an information recording medium having a plurality of recording layers; a selecting device for sequentially selecting one recording layer to record therein the record information, such that a recording area of the record information recorded into each of the plurality of recording layers substantially uniformly expands, in accordance with the recording of the record information; a generating device for generating virtual reference information (i) including logical address information on the information recording medium corresponding to the record information on a logical address space and (ii) associating the recording order of the record information with the logical address information corresponding to the recording position such that a recording position of the record information on the logical address space of the information recording medium is placed in a recording order of the record information onto the information recording medium; and a controlling device for controlling said recording device to record the generated virtual reference information onto the information recording medium, if the record information being newly recorded, said generating device generating the virtual reference information by rewriting the logical address information corresponding to at least the record information whose logical address information is changed due to the newly recording of the record information, out of the record information recorded on the information recording medium,
said information reproducing apparatus comprising:
a first reproducing device for reproducing the virtual reference information; and
a second reproducing device for reproducing the record information in the recording order of the record information onto the information recording medium, on the basis of the logical address information included in the virtual reference information reproduced by said first reproducing device.

9. An information reproducing method of reproducing the record information recorded on the information recording medium by the information recording apparatus comprising: a recording device capable of recording record information onto an information recording medium having a plurality of recording layers; a selecting device for sequentially selecting one recording layer to record therein the record information, such that a recording area of the record information recorded into each of the plurality of recording layers substantially uniformly expands, in accordance with the recording of the record information; a generating device for generating virtual reference information (i) including logical address information on the information recording medium corresponding to the record information on a logical address space and (ii) associating the recording order of the record information with the logical address information corresponding to the recording position such that a recording position of the record information on the logical address space of the information recording medium is placed in a recording order of the record information onto the information recording medium; and a controlling device for controlling said recording device to record the generated virtual reference information onto the information recording medium, if the record information being newly recorded, said generating device generating the virtual reference information by rewriting the logical address information corresponding to at least the record information whose logical address information is changed due to the newly recording of the record information, out of the record information recorded on the information recording medium,
said information reproducing method comprising:
a first reproducing process of reproducing the virtual reference information; and
a second reproducing process of reproducing the record information in the recording order of the record information onto the information recording medium, on the basis of the logical address information included in the virtual reference information reproduced in said first reproducing process.

10. A computer program product in a computer-readable medium for tangibly embodying a program of instructions executable by a computer provided in an information recording apparatus, to make the computer function as at least one portion of a recording device, a selecting device, a generating device, and a controlling device,
said information recording apparatus comprising:
said recording device capable of recording record information onto an information recording medium having a plurality of recording layers;
said selecting device for sequentially selecting one recording layer to record therein the record information, such that a recording area of the record information recorded into each of the plurality of recording layers substantially uniformly expands, in accordance with the recording of the record information;
said generating device for generating virtual reference information (i) including logical address information on the information recording medium corresponding to the record information on a logical address space and (ii) associating the recording order of the record information with the logical address information corresponding to the recording position such that a recording position of the record information on the logical address space of the information recording medium is placed in a recording order of the record information onto the information recording medium; and
said controlling device for controlling said recording device to record the generated virtual reference information onto the information recording medium,
if the record information being newly recorded, said generating device generating the virtual reference information by rewriting the logical address information corresponding to at least the record information whose logical address information is changed due to the newly recording of the record information, out of the record information recorded on the information recording medium.

11. A computer program product in a computer-readable medium for tangibly embodying a program of instructions executable by a computer provided in an information reproducing apparatus, to make the computer function as at least one portion of a first reproducing device and a second reproducing device,
said information reproducing apparatus for reproducing the record information recorded on the information recording medium by the information recording apparatus comprising: a recording device capable of recording record information onto an information recording medium having a plurality of recording layers; a selecting device for sequentially selecting one recording layer to record therein the record information, such that a recording area of the record information recorded into each of the plurality of recording layers substantially uniformly expands, in accordance with the recording of the record information; a generating device for generating virtual reference information (i) including logical address information on the information recording medium corresponding to the record information on a logical address space and (ii) associating the recording order of the record information with the logical address information corresponding to the recording position such that a recording position of the record information on the logical address space of the information recording medium is placed in a recording order of the record information onto the information recording medium; and a controlling device for controlling said recording device to record the generated virtual reference information onto the information recording medium, if the record information being newly recorded, said generating device generating the virtual reference information by rewriting the logical address information corresponding to at least the record information whose logical address information is changed due to the newly recording of the record information, out of the record information recorded on the information recording medium,
said information reproducing apparatus comprising:
said first reproducing device for reproducing the virtual reference information; and
said second reproducing device for reproducing the record information in the recording order of the record information onto the information recording medium, on the basis of the logical address information included in the virtual reference information reproduced by said first reproducing device.
